(19) United States
(12) Patent Application Publication
(10) Pub. No.: US 2016/0245441 A1
(43) Pub. Date: Aug. 25, 2016

(54) CONNECTOR, RELEASING TOOL, SET COMPRISING CONNECTOR AND RELEASING TOOL

(71) Applicant: VOSS AUTOMOTIVE GMBH, Wipperfürth (DE)

(72) Inventors: Roland KLEIN, Wipperfürth (DE); Eugen HEINRICHS, Gummersbach (DE)

(21) Appl. No.: 15/031,424

(22) PCT Filed: Oct. 22, 2014
(86) PCT No.: PCT/EP2014/002858

§ 371 Date: Apr. 22, 2016

(30) Foreign Application Priority Data
Oct. 22, 2013 (DE) 10 2013 017 442.2

(51) Int. Cl. F16L 37/098; F16L 33/00; B25B 13/50

(52) U.S. Cl. CPC F16L 37/0982; B25B 13/5033; F16L 33/00

(57) ABSTRACT

A connector, in particular for hose lines and/or pipelines, comprising at least one sleeve part and at least one insertion part, wherein the insertion part can be or is inserted into a receiving opening of the sleeve part and wherein at least one retaining element is provided for locking the insertion part in the sleeve part in a releasable manner. According to the invention, the retaining element and the insertion part have a two-piece design, and the retaining element can be radially expanded and can be or is mounted on an accommodating segment of the insertion part in a captive and rotationally locked manner and has at least one retaining arm having at least one retaining projection projecting on the outside. Such a connector is suitable particularly in the case of cramped installation conditions.

### FIELD OF THE INVENTION

The invention pertains to a connector for hose lines and/or pipelines which comprises at least one sleeve part and at least one insertion part, wherein the insertion part can be or is inserted into a receiving opening of the sleeve part, and wherein at least one retaining element is provided for releasably locking the insertion part in the sleeve part. The invention furthermore pertains to a releasing tool for releasing the connection between an insertion part with its retaining element and a sleeve part of such a connector, wherein an insertion gap is formed between the sleeve part and a protruding flange of the insertion part in the interlocked state of the connector, as well as to a set comprising a connector and a releasing tool for releasing the connection between an insertion part with its retaining element and a sleeve part of such a connector and to a retaining element for an insertion part of such a connector.

### BACKGROUND OF THE INVENTION

Connectors with an insertion part and a sleeve part are known from the prior art in many different variations. It is also known to provide retaining elements for securing the insertion part in the sleeve part. These retaining elements are also known in many different variations. For example, EP 0 999 398 B1 discloses a plug connector for hose lines and/or pipelines which consists of a sleeve part and an insertion part, wherein the insertion part is inserted into a receiving opening of the sleeve part with an insertion shaft. The inserted insertion part is sealed relative to the sleeve part by means of a circumferential seal and secured against being pulled out by means of a locking device. A hollow-cylindrical pin is arranged within the sleeve part and axially engages into the inserted insertion shaft. The circumferential seal is arranged in an annular chamber formed in a region lying radially between the pin of the sleeve part and the insertion shaft. The locking device consists of at least two diametrically opposite and radially elastic retaining arms of the insertion part which axially extend in the releasing direction approximately parallel to the insertion axis, wherein the respective retaining arms positively engage behind a corresponding locking surface formed in the receiving opening of the sleeve part. The locking device is realized integrally with the insertion part.

DE 8 604 217 U1 discloses another plug connector for pressure medium lines, particularly for connecting brake lines to a brake valve body, which consists of a housing and an insert with a through-bore that can be inserted into a connecting bore of the housing with its insertion shaft. The insert is secured against shifting in the axial direction by means of a retaining element and sealed with a circumferential seal arranged between the insertion shaft and the housing. The insert is furthermore secured against rotating relative to the housing by means of a positive connection. The retaining element on the one hand overlaps the outer side of the housing and therefore also the insert and on the other hand engages into the housing and presses locking projections into corresponding openings in the housing.

EP 2 224 156 A2 discloses a plug connector for medium lines which comprises an insertion part that can be inserted into a receiving opening of a connector counterpart in a sealed fashion with an insertion shaft and releasably secured against being pulled out with the aid of locking means. The locking means consist of at least two retaining arms of the insertion part which extend in the releasing direction approximately parallel to the insertion axis and are realized elastically in the radial direction. In the inserted state, the locking arms respectively engage positively or non-positively/positively behind a corresponding step provided within the receiving opening of the connector counterpart. The insertion part and the locking arms are realized in the form of an integral, monolithic molded part. A locking element is furthermore provided and movably connected to the insertion part in such a way that it blocks the locking means from being released in a securing position and releases the locking means for a release motion that unlocks the locking means in a releasing position. The locking means are furthermore realized in such a way that different forces have to be overcome in the inserting direction and the releasing direction. Such a plug connector is used on overflow oil lines and accordingly can be detached by taking hold of the end sections of the locking arms that protrude from the connector counterpart and are arranged adjacent to the insertion part.

EP 1 106 896 B1 discloses another plug connector for pressure medium lines which consists of a housing part and an insertion part, wherein the insertion part can be inserted into a receiving opening of the housing part in a sealed fashion with its insertion shaft and releasably locked therein by means of a separate retaining element with retaining means that can be elastically moved in the radial direction. This is achieved in that the retaining element is in a locking position seated between an inner annular step in the receiving opening and an outer annular step of the insertion shaft with its retaining means, wherein the retaining element is seated on the insertion shaft such that it can be axially displaced between a securing position and a releasing position, and wherein the retaining means are blocked from carrying out a radial releasing motion in the securing position and released for a radial release motion in the releasing position. A spring element is arranged between the insertion part and the retaining element in such a way that the retaining element can be automatically moved into the securing position due to the spring force and moved into the releasing position against the spring force. Consequently, the plug connector is axially assembled and disassembled with an axial lifting motion realized by attaching a releasing or lifting tool to the retaining element. In addition to the retaining element, it is therefore also necessary to provide a spring element in order to realize the desired locking effect.

FR 2930621 A1 discloses another variation of a plug connector for an overflow oil line. In order to interlock this plug connector, a retaining element that partially surrounds the insertion part is provided on the one hand and a tab-shaped locking element is provided on the other hand, wherein said locking element engages into and thereby spreads the retaining element radially outward in order to engage and retain locking projections in corresponding locking surfaces.

DE 39 24 173 A1 discloses a connector consisting of a connecting element that features a receiving bore for a pipe end provided with a fastening bead, as well as a sealing ring that encompasses the pipe end. In order to fix the pipe end in the connecting element, a liner can be pushed on the pipe end, wherein said liner can be inserted into a receiving bore and features a region that can be elastically deformed in the radial direction. This region is in its bore provided with a groove that can be interlocked with the fastening bead and forms a locking gear that engages into a groove in the connecting element. The pipe end is connected to the connecting region by means of a simple insertion process and released again by opening the locking gear.

It is particularly difficult to provide a releasable connector in locations, in which only little space is available, e.g. on a battery, because the actuation of the releasing tool is quite complicated in these locations.

The present invention is therefore based on the problem of proposing a connector, particularly for hose lines and/or pipelines, in which an insertion part and a sleeve part can assume an interlocking position and a releasing position, wherein only little space is required for a retaining element, which serves for releasably interlocking the insertion part and the sleeve part, but the connector parts can nevertheless be securely interlocked and released, and wherein the retaining element is arranged in a captive fashion in the interlocking position. With respect to the releasing tool for releasing the connected parts of the connector, it would be desirable to provide a tool that also makes it possible to easily and carefully separate the lines, on the ends of which the insertion part and the sleeve part are arranged, if the connector is used, for example, on a battery, i.e. in a location, in which only little space is available for the actuation of the releasing tool and for the connector itself.

### SUMMARY OF THE INVENTION

This problem is solved with a connector, particularly for hose lines and/or pipelines, comprising: at least one sleeve part and at least one insertion part, wherein the insertion part is insertable or inserted into a receiving opening of the sleeve part, and wherein at least one retaining element is provided for releasably locking the insertion part in the sleeve part, in which the retaining element and the insertion part have a two-piece design and the retaining element can be radially expanded, wherein said retaining element can be or is mounted on an accommodating segment of the insertion part in a captive and rotationally locked fashion and features at least one retaining arm with at least one outwardly protruding retaining projection, wherein the at least one retaining arm has a free end and an end fixed on the retaining element body and can be elastically moved in the radial direction relative to the insertion part in order to interlock and release the at least one retaining projection on/from at least one locking surface of the sleeve part, and wherein at least one guiding segment and/or at least one guiding surface is provided on the retaining element body adjacent to the free end of the at least one retaining arm in order to attach the releasing tool to the retaining element in a guided fashion and to thereby release the connection between the insertion part with its retaining element and the sleeve part. The above-defined objective is also attained with a releasing tool for releasing the connection between an insertion part provided with a retaining element and a sleeve part of a connector, wherein an insertion gap is provided between the sleeve part and a protruding flange of the insertion part in the interlocked state of the connector, in which the releasing tool has at least one fork-shaped section with a c-shaped opening, wherein the c-shaped opening features retaining edges for engaging on and retaining the retaining arms and at least one guiding segment and/or at least one guiding surface of the retaining element. The above-defined problem is furthermore solved with a set comprising a connector and a releasing tool for releasing the connection between an insertion part provided with a retaining element and a sleeve part of the connector, in which the sleeve part and the insertion part are realized in such a way that an insertion gap for inserting the releasing tool remains after the sleeve part and the insertion part with its retaining element have been inserted into one another, wherein a section of the releasing tool is realized in a fork-shaped fashion with at least one c-shaped opening in order to be inserted into the insertion gap, and wherein the inner c-shaped opening is dimensioned such that retaining edges of the inner opening are retained on at least one guiding segment and/or at least one guiding surface of the retaining element body adjacent to retaining arms of the retaining element when the releasing tool is attached to the retaining element and retaining projections of the retaining arms of the retaining element are radially moved so far in the direction of the insertion part that they are disengaged from the locking surface of the sleeve part. Enhancements of the invention are defined in the dependent claims.

The invention therefore proposes a connector, particularly for hose lines and/or pipelines, which comprises an insertion part and a sleeve part. The insertion part is enclosed by the retaining element with c-shaped cross section in the region of the accommodating segment. Depending on the longitudinal gap width of the c-shaped retaining element, this retaining element is—if the longitudinal gap is sufficiently wide—attached to the insertion part radially and otherwise attached to the insertion part axially and seated in the accommodating segment. The latter is advantageously bordered by protruding sections of the insertion part, particularly by flanges, such that the retaining element can be captively held in the accommodating segment in the axial direction, i.e. secured against being inadvertently released. In addition, at least one offset, particularly a shoulder, may be formed in the accommodating segment, wherein the retaining element can be respectively supported on or engaged with said offset with a complementary offset, particularly a shoulder.

The retaining element features retaining projections for interlocking with the locking surface of the sleeve part, in particular, in a circumferential locking groove of the sleeve part which is realized on its inner side. It is provided with a collar body that has a c-shaped cross section and comprises at least one elastically movable retaining arm with at least one retaining projection arranged on the outer side thereof. The collar body may be realized closed or open and is held on the insertion part in a clamped fashion in the accommodating segment thereof. The retaining arms advantageously extend in the axial direction of the retaining element or parallel to the insertion axis of the insertion part, i.e. in the inserting direction, and can be elastically moved relative to the insertion part in the radial direction. The interlocking position of the retaining element can be released by attaching the releasing tool to the respective free end of the elastic retaining arms of the retaining element. For this purpose, the releasing tool, which is realized in a fork-like fashion in at least one section, particularly on its end, features a c-shaped opening with such a width that, when engaging on the free ends of the retaining arms, it pushes these retaining arms so far in the direction of the insertion part that the retaining projections are disengaged from the locking surface in the sleeve part. The C-shape of the inner opening comprises a rounded section with such a radius that outside contact with the retaining element body is possible, as well as two straight sections that approximately lie opposite of one another, wherein these straight sections respectively comprise or form the retaining edges and are arranged approximately parallel to one another. Since the retaining edges on the c-shaped opening of the releasing tool engage on the guiding surfaces in a retaining fashion, the releasing tool is held on the retaining element and the insertion part can be separated from the sleeve part by pulling on the releasing tool in the direction of the insertion part. It is therefore not necessary to pull on the lines, the ends of which are respectively provided with the insertion part and the sleeve part, such that these lines and the respective connections with the insertion part and the sleeve part can be protected. Due to the specially designed shape of the releasing tool in the region of the c-shaped opening with the retaining edges that engage on the guiding surfaces and/or guiding segments of the retaining element, the releasing tool can engage on the insertion part and the insertion part with its retaining element can be separated from the sleeve part by taking hold of and pulling the releasing tool away from the sleeve part. In contrast to the retaining edges of releasing tools according to the prior art such as, for example, EP 1 106 896 B1 or DE 20 2005 011 401 U1, the retaining edge on the releasing tool serves for respectively holding the releasing tool on the insertion part or its retaining element and for simultaneously pushing back the at least one retaining arm and thereby releasing the retaining projection(s) from its/their interlocking position in the sleeve part. At least one guiding surface and/or at least one guiding segment may be provided, but at least a region on the retaining element or of its body, which serves for attaching and guiding the releasing tool, is provided in any case. For this purpose, said region may be realized in the form of a suitably shaped guiding segment or in the form of a suitably arranged and shaped guiding surface for attaching and guiding the releasing tool.

In order to enable the releasing tool to reach the retaining arms of the retaining element, an insertion gap is provided in the interlocked state between the insertion part with its retaining element and the sleeve part. For the release process, the releasing tool is inserted into the insertion gap between the end of the sleeve part and a protruding section, particularly a flange, of the insertion part with its fork-shaped end or section such that it engages on the free ends of the retaining arms and pushes these retaining arms in the direction of the insertion part. The releasing tool may feature lead-in bevels for simplifying the insertion into the insertion gap in order to encompass the insertion part and engage on the free ends of the retaining arms.

Due to the arrangement of the retaining element in the interior of the sleeve part, an inadvertent release of the connection between the sleeve part and the insertion part can be reliably prevented. The retaining element cannot be actuated from outside without a releasing tool. In contrast to the prior art, the retaining element contains no parts that protrude outward and could cause an inadvertent actuation thereof. Another advantage over the prior art can be seen in that the retaining element, which can be attached to the insertion part and is interlocked and held in the sleeve part during the assembly of the insertion part and the sleeve part, makes it possible to create a modular system that provides a very broad variety. This building block system or modular system may prove highly advantageous, particularly in the tubing of batteries, because a broad variety of different connectors, which are suitably designed for the respective application, can be easily created. In this case, the same retaining element is clipped on differently shaped insertion parts because it is subsequently retained in the sleeve part during its connection to the insertion part. Since the retaining element has a less complex shape than comparable retaining elements known from the prior art, it is easier to remove the retaining element from the mold after its manufacture than corresponding retaining elements according to the prior art because fewer cores have to be provided in the production tool, e.g. an injection mold, during the manufacture.

The collar body of the retaining element advantageously features two retaining arms with retaining projections which are arranged opposite of one another, wherein the retaining projections are respectively arranged on a retaining arm in the region of its free end in order to disengage the retaining projections from the locking surface of the sleeve part due to the attachment of the releasing tool to the free ends. Since two retaining arms are provided and arranged opposite of one another referred to the insertion part, the fork-shaped section of the releasing tool can be attached in a particularly simple fashion. In this case, the retaining edges of the inner opening of the fork-shaped section of the releasing tool may be realized longer than the distance corresponding to half the diameter of the insertion part with its retaining element attached thereto. This allows a particularly secure engagement on the retaining arms and simultaneously ensures that the free ends of the retaining arms are completely pushed down in the direction of the insertion part.

In contrast to the above-described prior art, no outwardly protruding locking and unlocking elements exist in the interlocked state such that even a large number of connectors, which should be arranged within a small space, can be very easily fitted with the retaining element. The connector therefore can be very advantageously used, in particular, on bundled lines in the form of a so-called flying cut-off point, at which the plug connection can be released at any time with the aid of the releasing tool. Since there are no opening or releasing elements that have to be manually actuated by being taken hold of in order to release the plug connection between the sleeve part and the insertion part with its retaining element, the connector can be particularly well protected from unauthorized separation. A releasing tool or the releasing tool is required for releasing the connection and not only simplifies the disassembly or the separation of the parts from one another, but can also simplify the assembly if the retaining arms are pushed down by the releasing tool in order to allow or to simplify a quick engagement of the retaining projections into a corresponding locking groove or behind the locking surface in the sleeve part, respectively.

At least one rotational lock may be provided in order to prevent an inadvertent rotation of the collar body or of the retaining element about the insertion part, particularly when attempting to attach the releasing tool. Particularly the insertion part features such a rotational lock for the retaining element. This rotational lock may be formed, for example, by at least one element that radially protrudes from the accommodating segment for accommodating the retaining element. This element can engage into a gap between the ends of the retaining element collar body with its c-shaped cross section and thereby prevent a rotation of the retaining element about the longitudinal axis of the insertion part. Furthermore, the rotational lock may be realized in the form of a positive engagement between at least one protruding element and at least one groove on the outer side of the insertion part and on the inner side of the retaining element collar body. Webs extending in the longitudinal direction of the insertion part are particularly suitable as protruding or projecting elements. In addition, the rotational lock may be simply realized, for example, in the form of at least one flattened region that cooperates with a flattened region of the retaining element. It is also possible to use combinations of the described measures in order to prevent the retaining element from rotating relative to the insertion part.

At least one axial supporting surface for the retaining element is advantageously provided on the insertion part. This makes it possible to transmit a force from the retaining element to the insertion part.

In order to achieve a particularly secure retention of the retaining edges of the releasing tool in the region of the retaining element, this retaining element or its collar body respectively features at least one guiding segment and/or at least one guiding surface, i.e. at least one region that serves for guiding the releasing tool, adjacent to the at least one retaining arm. Such a guiding segment or guiding surface may be realized, in particular, in the form of a flattened and/or pocketed region for guiding the releasing tool for releasing the connection between the insertion part with its retaining element and the sleeve part. The releasing tool therefore is automatically centered and guided into the correct position, wherein the arrangement of the flattened or pocketed regions adjacent to the at least one retaining arm enables the releasing tool to push the retaining arm sufficiently far in the direction toward the insertion part for releasing the connection between the insertion part and the sleeve part, i.e. for disengaging the retaining projections from the locking surfaces of the sleeve part.

The accommodating segment provided on the insertion part for accommodating the retaining element is on one end advantageously bordered by at least one protruding flange, which also defines and borders on one side of the insertion gap. The other side of the insertion gap is defined by the end face of the sleeve part. The retaining element is advantageously accommodated in the accommodating segment in such a way that the respective free end of the at least one retaining arm of the retaining element lies adjacent to the flange and in the insertion gap after the insertion part and the sleeve part have been inserted into one another. This flange may also serve, in particular, as a contact surface for the releasing tool while it is inserted into the insertion gap. The opening width of the space defined by the at least one web, which at least partially surrounds the inner c-shaped opening of the fork-shaped section of the releasing tool at a distance therefrom, is advantageously dimensioned slightly larger than the outside diameter of the sleeve part, but smaller than the outside diameter of the flange of the insertion part. In this way, the flange cannot be encompassed, but the sleeve part can. This may also serve as a positioning aid for the releasing tool because this releasing tool can only be inserted into the insertion gap and cause a separation of the connection between the sleeve part and the insertion part with its retaining element in one direction.

Due to the two-piece design of the insertion part and the retaining element, these components can be made of different materials, wherein the insertion part may be made, in particular, of metal and/or plastic, especially plastic containing glass fibers, and the retaining element may be made of metal and/or plastic. The insertion part and the retaining element may particularly consist of plastics with a different glass fiber content, wherein the glass fiber content of the retaining element may be lower than the glass fiber content of the insertion part. The sleeve part may likewise consist of metal and/or plastic, wherein the material selection may be adapted, in particular, to the two other components. For example, the sleeve part may be made of aluminum. Such a sleeve part is particularly suitable for soldering in a cooling plate. The sleeve part is realized in the form of a rotationally symmetrical turned part in this case. The retaining element is accordingly arranged on the insertion part.

The two-piece design of the insertion part and the retaining element allows a suitable and different material selection of all components of the connector. The retaining element can also be used, for example, on simple machined insertion part contours. The sleeve part may also be simply produced by means of machining such that no milling work is required. The advantageous two-piece design of the insertion part and the retaining element makes it possible to utilize the retaining element in a highly variable fashion, particularly to always realize this retaining element in the form of one and the same element that can be attached to various types of insertion parts. Depending on the respective application of the connector, it is also possible to use high-temperature materials for the insertion part, as well as for the retaining element and the sleeve part. If the insertion part, the retaining element and the sleeve part are made of different materials, particularly of different plastics, it is furthermore possible, for example, to prevent a so-called match cord effect, i.e. the inadvertent advance of a fire or the like beyond the connector. Such a match cord effect can be prevented by using different materials for the insertion part, the retaining element and the sleeve part. For example, the insertion part may be made of polyphenylene sulfide (PPS) such as Fortron® 1140L4 at least in the accommodating segment, to which the retaining element is attached, the retaining element may be made of glass-fiber reinforced polyamide such as PA12GF30, and the sleeve part may be made of aluminum. Other material combinations may naturally also be considered. If the insertion part and the retaining element are made of glass-fiber reinforced plastic, it is furthermore advantageous to provide the insertion part with a higher glass fiber content than the retaining element because the insertion part is usually subjected to higher forces than the retaining element, which is accommodated in the interior of the sleeve part after the interlocking process, and the retaining arms of the retaining element should have a sufficient elasticity for respectively being actuated or deflected by the releasing tool.

It is furthermore advantageous to provide at least one offset for engaging with a complementary offset of the insertion part in an end region of the retaining element on its inner side. In this way, the retaining element can be held on the insertion part in a more stable fashion because it is possible to create an additional axial limit stop, on which the retaining element engages. The accommodating segment of the insertion part may accordingly have a stepped shape, wherein the retaining element can secure itself on each of the steps.

The c-shaped design of the retaining element also makes it possible to attach this retaining element to integrally molded or shaped or upset pipe ends, namely even if no rotational lock is provided at this location. Since the retaining element is attached radially, it can also be attached to thusly formed pipe ends without any problems in order to thereby captively secure the retaining element after the insertion of the correspondingly designed pipe end into a sleeve part. If diverse variations of connectors or splitters are required, it is also possible to machine simple variations thereof in order to provide them with a suitable design for the attachment of the retaining element. In this case, it would be possible, in principle, to utilize a modular system of sorts, in which the same retaining element also can be attached to diverse designs of connectors or connector parts, particularly after machining simple connector parts in order to provide them with a corresponding accommodating segment for attaching the retaining element.

Instead of providing a rotational lock for the retaining element in the form of an element that radially protrudes from the accommodating segment for accommodating the retaining element and extends axially parallel to the longitudinal direction of the insertion part or the insertion axis, it would also be conceivable to use other rotational locks. For example, a rotational lock for machined insertion parts in the form of a transverse bore or surface in the contour of the insertion part may be produced during the machining process.

In each of the embodiments, a captive arrangement is not only realized for the retaining element accommodated in the sleeve part after the assembly of the insertion part with its retaining element and the sleeve part, i.e. the assembly of the connector, but also for the connection between the insertion part with its retaining element and the sleeve part, namely until the connection between the sleeve part and the insertion part with its retaining element is once again released with the releasing tool.

Due to the two-piece design of the insertion part and the retaining element, it is furthermore possible to replace the retaining element in case it is damaged. This is not possible in the one-piece solutions known from the prior art. In such systems according to the prior art, the insertion part has to be replaced together with the line if a defect occurs.

The insertion part and the sleeve part can be connected to various types of hose lines and pipelines or units by means of different connecting techniques. For example, they may be connected to a hose by using a hose clamp or a plug connector, connected to a pipeline such as a polyamide pipeline by means of an expansion fitting or even connected by means of an integral connection, in which metallic pipe ends are welded or soldered to a metallic insertion part.

Instead of using a retaining element made of plastic, it is also possible to use a metallic retaining element in order to create a connector that is suitable for high-temperature applications such as, e.g., in the exhaust gas system of a motor vehicle. In this case, special high-temperature materials may be alternatively or additionally used for the insertion part, as well as for the retaining element and the sleeve part.

It is particularly advantageous to provide a positioning aid for the releasing tool to be attached to the connector and to be inserted into the insertion gap between the protruding flange of the insertion part and the end of the sleeve part if the connector is part of a bundle of connectors and particularly difficult to access such that the releasing tool has to be attached and the connection between the sleeve part and the insertion part with its retaining element has to be released without visual contact or essentially without visual contact. Such a positioning aid may be realized in that the collar body of the retaining element features on its outer side protruding elements that only allow the fork-shaped section of the releasing tool to engage in a single alignment or, if applicable, in two diametrically opposite positions of the releasing tool. Incorrect positioning of the releasing tool can thereby be prevented. The protruding elements are arranged, in particular, in the region of the collar body which is located adjacent to the retaining arms provided with retaining projections. Since the retaining element is prevented from rotating relative to the insertion part due to the rotational lock, the retaining element always has a defined orientation and therefore a defined position on the insertion part such that the releasing tool is always correctly positioned relative to the retaining arms during its attachment in the region of the protruding elements. If applicable, the elements that protrude from the outer side of the collar body and serve as a positioning aid for the releasing tool can be visually detected, e.g., by realizing these elements with a different color such that the insertion gap for inserting the releasing tool for releasing the connection between the sleeve part and the insertion part with its retaining element can be very quickly and easily located in order to release the connection.

The releasing tool respectively is radially inserted into the insertion gap formed between the flange of the insertion part and the end of the sleeve part in order to realize the actuation, i.e. the release of the connection between the sleeve part and the insertion part with its retaining element, wherein the at least one retaining arm of the retaining element is radially accessible through this insertion gap. The elements or projections protruding from the outer side of the collar body may serve for defining the position of the releasing tool, particularly for centering the fork-shaped section of the releasing tool being inserted into the insertion gap. It is basically possible to use various types of releasing tools which allow an actuation of the at least one retaining arm of the retaining element in such a way that said retaining arm is radially pushed in the direction of the insertion part in order to disengage the at least one retaining projection on the retaining arm from a locking surface in the sleeve part.

The connector can be released without any problems by means of the releasing tool due to the elastic retaining arms or spring arms, which can be deformed in the direction of the insertion part, i.e. inward referred to the retaining element, and due to a sufficient space or clearance between the free end of the retaining arms and the outer side of the insertion part in the region of the accommodating segment for the retaining element. In the remaining region of the collar body, the retaining element may in comparison be accommodated on the outer side of the insertion part without clearance in the region of the accommodating segment for the retaining element. In the insertion gap, the releasing tool can engage on the free ends of the elastic retaining arms of the retaining element in order to realize their actuation. As already mentioned above, the releasing tool is in the region of its inner opening guided on retaining edges that engage on the outer side of the guiding surfaces and/or guiding segments of the retaining element body adjacent to the retaining arms of the retaining element. The web of the at least one fork-shaped section of the releasing tool, which at least partially encloses the c-shaped opening, extends beyond the sleeve part adjacent to the insertion gap as already mentioned above such that the insertion part can be removed from the sleeve part or vice versa after the fork-shaped section of the releasing tool has engaged on the retaining arms of the retaining element and pushed or moved these retaining arms in the direction of the accommodating segment of the insertion part.

Instead of using at least two separate and diametrically opposite retaining arms, it would also be possible to provide interconnected retaining arms, which have a greater circumferential extent than the retaining element and therefore also the insertion part, on their free ends in order to provide superior access for the releasing tool. It is furthermore possible to provide only one retaining arm that is provided with a transverse arm on its free end in order to enlarge the surface for the attachment of the releasing tool and to thereby unlock or release the interlocked connector parts. For example, the connection between at least two retaining arms may be realized in such a way that the connecting part particularly yields or is deformed outward when the releasing tool for releasing the connection between the sleeve part and the insertion part is attached in order to thereby move the retaining arms in the insertion gap in the direction of the insertion part or its accommodating segment, respectively.

It is furthermore possible to provide at least one connection indicator means that makes it possible to ascertain whether the plug connection between the insertion part and the sleeve part with its retaining element has already been released and subsequently reconnected. This can be relevant in connectors that convey critical mediums. Such a connection indicator means may be realized, for example, in the form of an acoustically and/or visually perceivable indicator means such as, e.g., at least one web that is formed between the retaining arm and the collar or retaining element body of the retaining element and breaks when the retaining arm is unlocked from its interlocking position, i.e. when the retaining arm is moved inward relative to the retaining element, wherein this can be perceived acoustically, as well as optically, i.e. visually, due to the subsequently missing web. For example, the web may also be realized with a different color in order to allow an even easier optical control of its integrity.

### DETAILED DESCRIPTION OF THE DRAWINGS

Exemplary embodiments of the invention are described in greater detail below with reference to the drawings. In these drawings:

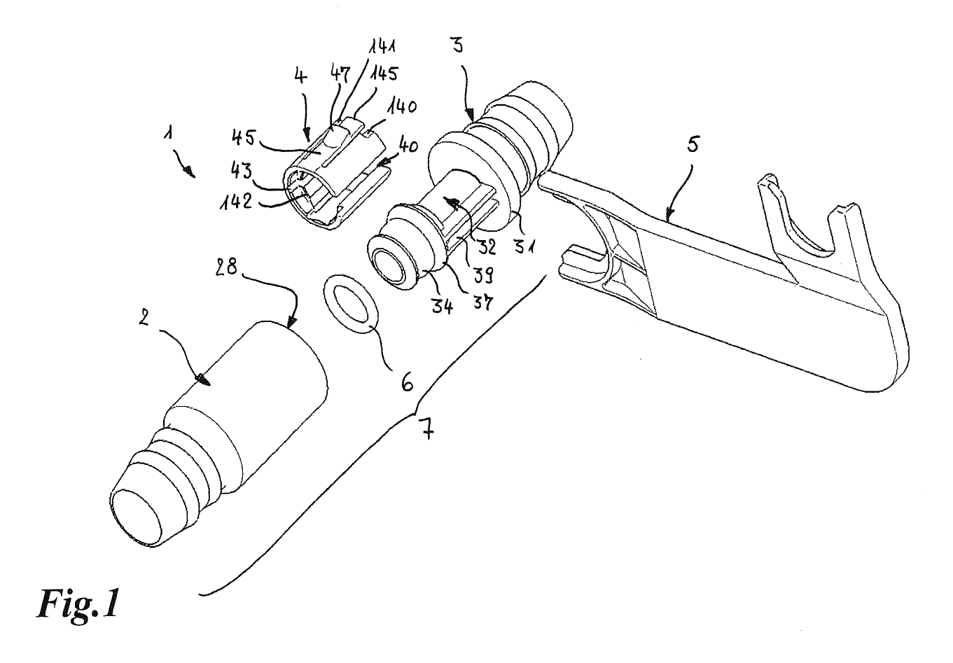

FIG. 1 shows a perspective exploded view of an inventive set comprising an inventive connector and a corresponding releasing tool,

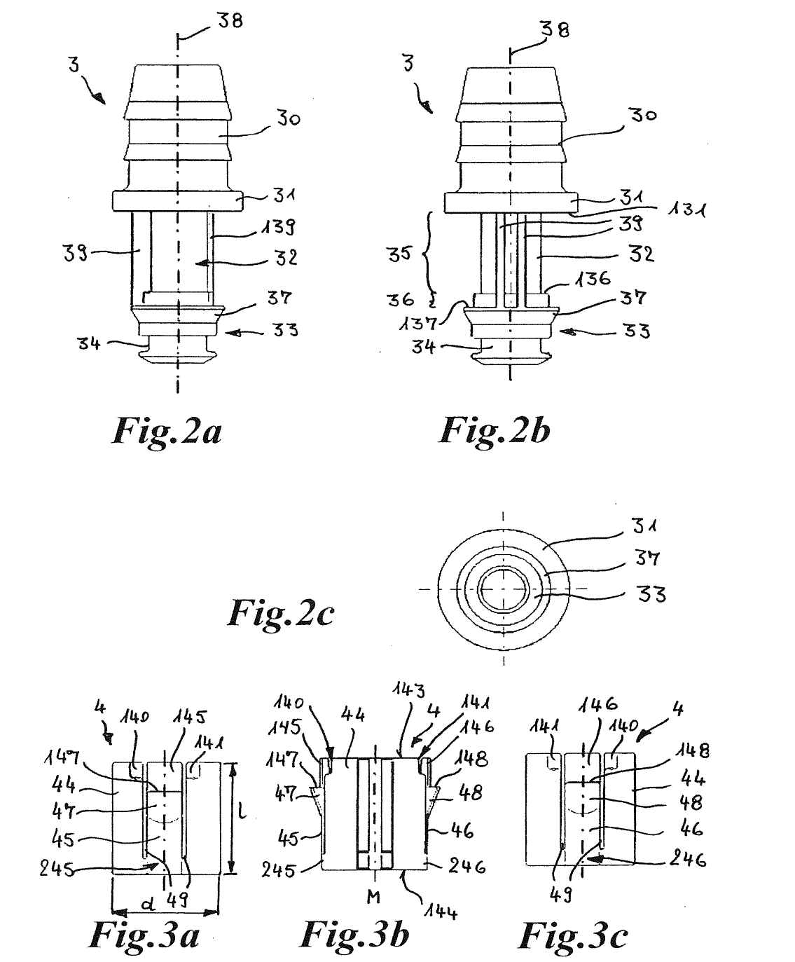

FIGS. 2a-2c show side views and a top view of an inventive insertion part,

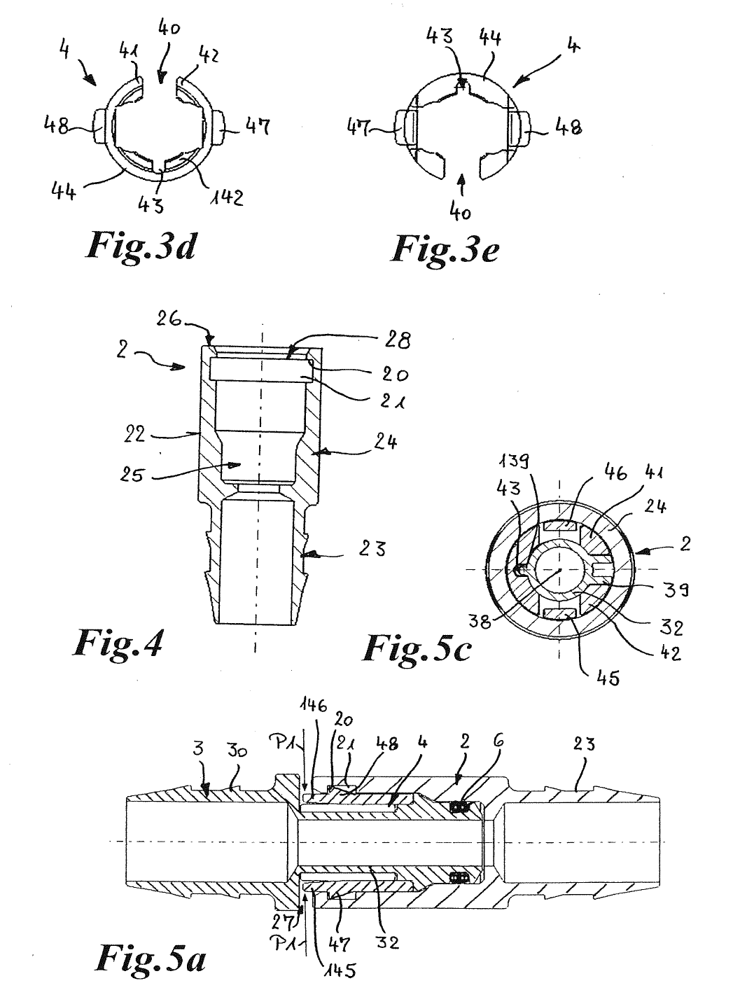

FIGS. 3a-3e show side views, as well as top views and bottom views, of an inventive retaining element,

FIG. 4 shows a longitudinal section through an inventive sleeve part,

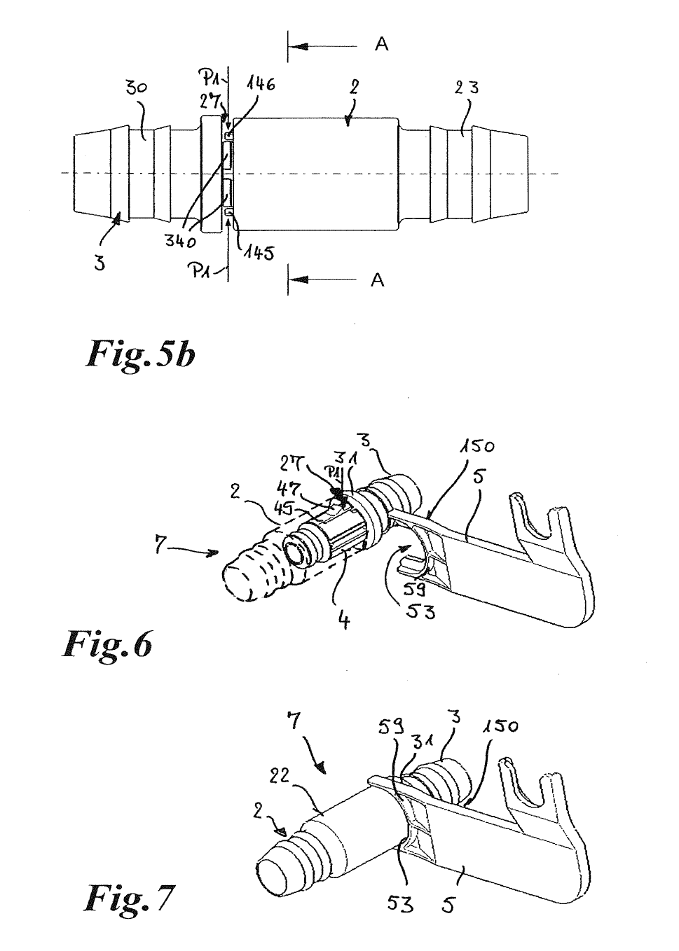

FIG. 5a shows a longitudinal section through an inventive insertion part provided with a retaining element and a sleeve part connected thereto,

FIG. 5b shows a side view of the connector according to FIG. 5a,

FIG. 5c shows a cross section through the connector according to FIG. 5b along the line A-A,

FIG. 6 shows a perspective view of the insertion part with the interconnected sleeve part according to FIGS. 5a, 5b, 5c, which is merely indicated with broken lines in this case, as well as an inventive releasing tool for releasing the interlocked connection between the sleeve part and the insertion part with its retaining element,

FIG. 7 shows a perspective view of the inventive connector according to FIG. 6, in which the releasing tool is inserted into an insertion gap in order to release the connection,

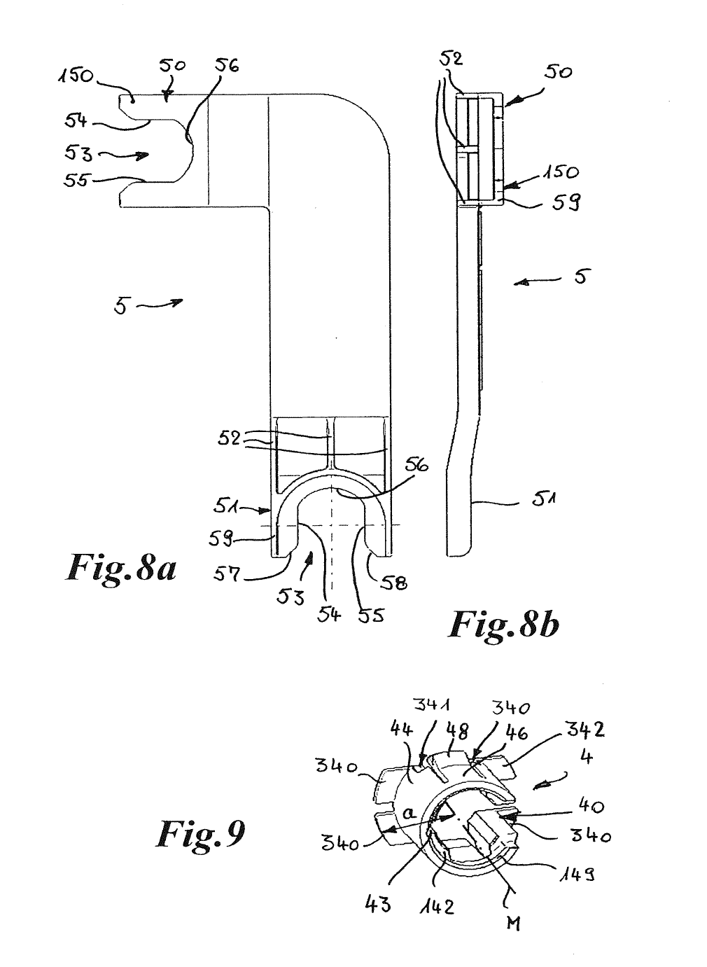

FIGS. 8a and 8b show a top view and a side view of the releasing tool according to FIG. 1 and FIGS. 6 and 7,

FIG. 9 shows a perspective view of an alternative embodiment of an inventive retaining element,

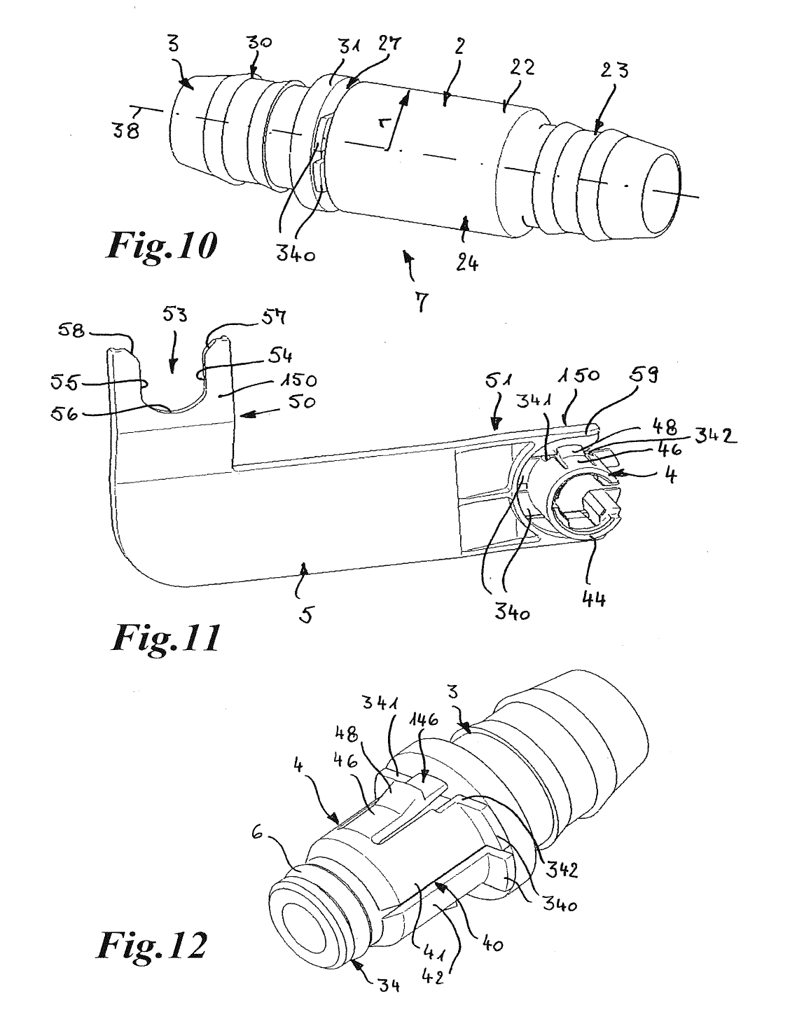

FIG. 10 shows a perspective view of an inventive connector with the retaining element according to FIG. 9,

FIG. 11 shows a perspective view of an inventive releasing tool that is attached to the retaining arms of the retaining element according to FIG. 9 with its c-shaped opening,

FIG. 12 shows a perspective view of another embodiment of an inventive connector that is provided with a retaining element according to FIG. 9,

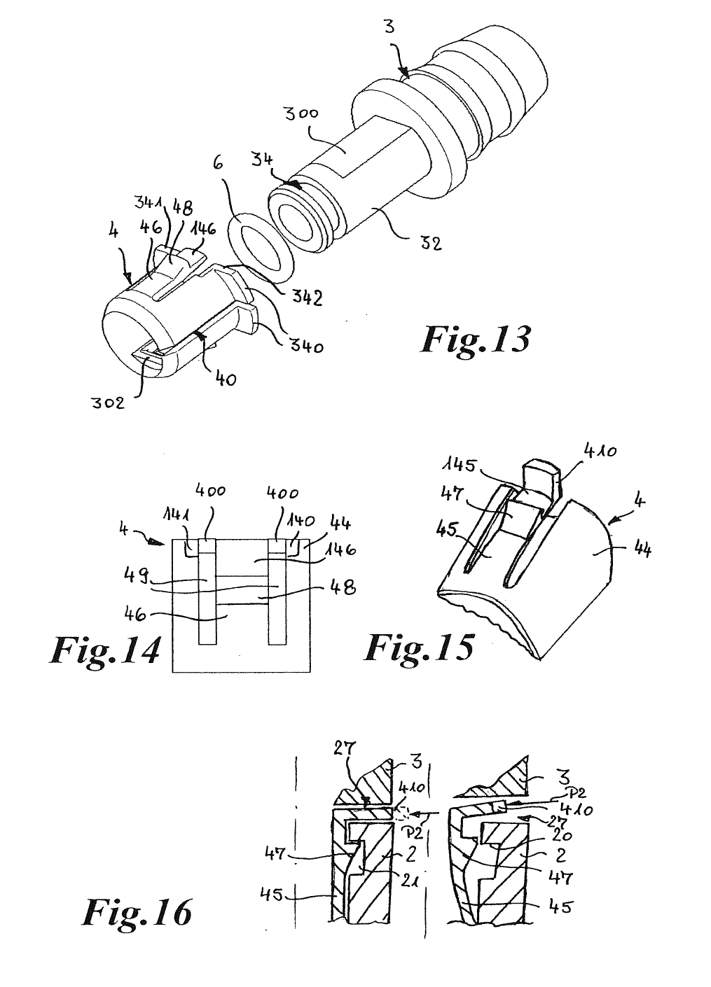

FIG. 13 shows a perspective exploded view of the connector according to FIG. 12,

FIG. 14 shows a side view of an inventive retaining element provided with connection indicator means,

FIG. 15 shows a partial perspective view of an inventive retaining element with protruding tabs on the free ends of the retaining arms, and

FIG. 16 shows a schematic detail of an inventive retaining arm in the interlocking position with a locking surface of a sleeve part and in the released position, namely with and without protruding elements.

### DETAILED DESCRIPTION OF THE INVENTION

FIG. 1 shows a perspective exploded view of a set 1 comprising a sleeve part 2, an insertion part 3 and a retaining element 4, which jointly form a connector 7, as well as a releasing tool 5. FIG. 1 furthermore shows a ring seal 6, which is attached to the end of the insertion part 3 prior to connecting the insertion part 3 to the sleeve part 2, in order to produce a sealed connection between the insertion part and the sleeve part. After the attachment of the retaining element 4, the insertion part 3 is accommodated in a receiving opening 28 of the sleeve part 2 and interlocked therein.

According to the detailed views of the insertion part illustrated in FIG. 2a to FIG. 2c, the insertion part 3 features a connecting section 30 for expansion-fitting a pipeline thereon. Instead of using such a connecting section 30, in particular, for expansion-fitting a polyamide pipe thereon, it is also possible to provide a hose connection that makes it possible to connect a hose, for example, with the aid of a hose clamp. It is furthermore possible to realize the connecting section 30 in the form of a plug connector and/or in a suitable fashion for producing an integral connection, for example, by means of welding or soldering. The connecting section 30 may not only serve for connecting a hose line and/or pipeline directly or via a sleeve part, but also for connecting other medium-conveying devices or devices, through which a medium can flow, e.g. units.

The connecting section 30 is separated from in accommodating segment 32 for accommodating the retaining element 4 by a protruding flange 31. An end section 33 arranged adjacent to the accommodating segment 32 comprises a groove 34 for accommodating the ring seal 6. After the attachment of the retaining element 4 to the insertion part 3, the ring seal 6 lies underneath the retaining element, i.e. it is outwardly overlapped by this retaining element. The accommodating segment 32 is realized in a stepped fashion and features a first inner section 35, which has the smallest diameter and the greatest length referred to the accommodating segment 32, as well as a second section 36, which has a larger diameter than the first section 35, wherein the diameter of the second section 36 is smaller than that of the protruding section 37 defining the end of the accommodating segment 32. According to FIG. 6, it is therefore possible to support and captively hold the retaining element 4 accommodated in the accommodating segment 32 axially between the flange 31 or its axial surface 131 and the protruding section 37 or its axial surface 137. In this context, the term “captive” refers to securing a component against being inadvertently released. The axial contact surfaces 131 and 137 not only serve for positioning the retaining element 4, but also for fixing the retaining element and for the transmission of forces in the separating direction of the insertion part 3 from the sleeve part 2.

The top views of the retaining element illustrated in FIG. 1 and FIG. 3d, in particular, show that the circumferential wall of the collar body 44 has a smaller wall thickness than the remaining collar body 44 in the region that should be brought in contact with the second section 36 of the accommodating segment 32 of the insertion part 3. In this way, an axial contact surface 142 is created on the retaining element 4, wherein this axial contact surface is supported on an axial contact surface 136 of the second section 36. The retaining element 4 is thereby secured against axially shifting on the accommodating segment 32.

Two webs 39 extending in the longitudinal direction, i.e. parallel to the longitudinal connector axis 38, are provided order to rotationally lock the retaining element once it is accommodated on the accommodating segment 32. This is also illustrated in FIG. 5c. It is likewise possible to provide one wider web instead of two individual webs. A greater number of webs may also be provided, wherein the purpose of these webs 39 consists of preventing a rotation of the retaining element 3 about the longitudinal connector axis 38. This is illustrated particularly well in FIG. 5c. In this case, the radial clearance toward the insertion part, as well as in the sleeve part, is advantageously small such that no more than a slight tilt can occur during the assembly of the insertion part with its retaining element and the sleeve part, but a clean insertion is ensured in any case.

According to the top view and the bottom view of the retaining element illustrated in FIGS. 3d and 3e, as well as the perspective view illustrated in FIG. 1, in particular, this retaining element is respectively realized in an approximately c-shaped fashion in the top view and in a cross section. This makes it possible to radially expand the retaining element 4 and to radially attach the retaining element to the accommodating segment 32 of the insertion part 3 parallel to the longitudinal connector axis 38. After the attachment of the retaining element 4 to the accommodating segment 32 of the insertion part 3, the web or webs 39 are accommodated in a gap 40 formed due to the C-shape of the retaining element 4 between its ends 41, 42. This is indicated in FIGS. 5c and 6, however, for a retaining element that is modified in comparison with the retaining element illustrated in FIGS. 3a-3e by providing projecting elements 340 on the ends of the retaining arms 45, 46.

FIGS. 3d and 3e furthermore show that a longitudinal groove 23 is formed on the collar body 44 diametrically opposite of the gap 40. This longitudinal groove serves for additionally fixing the retaining element 4 on the insertion part 3 by creating a rotational lock and promotes the elasticity during the expansion of the retaining element when it is attached to the insertion part 3. The accommodating segment 32 of the insertion part 3 features an additional web 139 opposite of the webs 39. According to FIG. 2a, the web 139 extends in the longitudinal direction of the insertion part 3 approximately opposite of the webs 39 referred to the insertion part.

The collar body 44 of the retaining element 4 comprises two oppositely arranged retaining arms 45, 46 with retaining projections 47, 48 arranged thereon. The retaining arms 45, 46 extend in the longitudinal direction of the retaining element, i.e. parallel to the longitudinal connector axis 38, after the retaining element has been positioned on the insertion part 3. The retaining arms 45, 46 are respectively realized approximately perpendicular to the gap 40 and to the longitudinal groove 43 in the collar body 44. This is illustrated particularly well in FIGS. 3d and 3e. The retaining projections 47, 48 are arranged on the retaining arms 45, 46 in such a position that their ends 147, 148, which respectively form a shoulder or hook, point in the direction of the respective free end 145, 146 of the two retaining arms 45, 46. The retaining arms engage on the locking surface 20 of the sleeve part 2 with these ends 147 148 (see FIG. 5a).

The retaining arms 45, 46 are elastically arranged on the collar body 4 and separated from the remaining collar body 4 by providing flanking gaps 49. This is illustrated, in particular, in FIGS. 3a and 3c, which respectively show side views of the retaining element 4. FIG. 3b, which shows a side view of the retaining element 4 which is turned by 90° and looks up at the gap 40 between the two ends 41, 42 of the collar body 44 of the retaining element 4, particularly shows that the two opposite retaining arms 45, 46 slightly protrude outward over the collar body 44 of the retaining element 4 with their free ends 145, 146 such that the two retaining projections 47, 48 can be engaged with at least one locking surface 20 of a locking groove 21 (see FIGS. 4 and 5a). Due to the elastic design of the retaining arms 45, 46, which are only fixed on the collar body 44 on one end identified by the reference symbols 245, 246, the retaining projections 47, 48 automatically interlock in the locking groove 21 of the sleeve part 2 or on the locking surface 20 after the insertion into the locking groove.

According to FIG. 3a, the retaining element 4 has a length l and a diameter d, wherein it is preferred that I≧d in order to ensure a clean insertion and to reliably prevent tilting, naturally in connection with a narrow clearance referred to the sleeve part, i.e. its inside diameter. The retaining element 4 contacts the two axial surfaces 131, 137 of the plug connector 3 with its two axial end faces 143, 144. In this case, the retaining element 4 can be fitted on the accommodating segment 32 in a relatively clearance-free fashion.

The releasing tool 5 is provided in order to once again release the interlocked connection between the retaining projections 47, 48 and the locking groove 21 or the locking surface 20 of the sleeve part 2. This is illustrated in greater detail in the perspective view shown in FIG. 1, as well as in the top view and the side view shown in FIGS. 8a and 8b. FIG. 8b, in particular, shows that the releasing tool 5 is essentially flat and features two elbowed, fork-shaped end sections 50, 51. In the top view, the releasing tool is approximately L-shape. The two elbowed, fork-shaped sections 50, 51 are reinforced with different webs 52. Both sections 50, 51 respectively feature an opening 53 that comprises two straight retaining edges 54, 55 and a curved, arc-shaped section 56 that connects the two retaining edges to one another. In the end region, the two straight retaining edges 54, 55 of the opening 53 of the two elbowed, fork-shaped sections 50, 51 transform into insertion edges 57, 58 that open conically. A web 59 extends parallel to the two retaining edges 54, 55 and the arc-shaped section 56 at a distance from the inner opening 53 of the two elbowed, fork-shaped sections 50, 51. This web serves as a positioning aid and as a limit stop. It can contact the outer side 22 of the sleeve part 2 as indicated in FIG. 7. As soon as the web 59 contacts the outer side 22 of the sleeve part 2, it is correctly positioned for respectively releasing the retaining projections 47, 48 from the locking groove 21 or the locking surface 20 of the sleeve part 2.

In order to release the interlocked connection between the retaining projections 47, 48 of the retaining element 4 arranged on the insertion part 3 and the locking groove 21 of the sleeve part 2, the releasing tool 5 engages on the two retaining arms 45, 46 in the region of the free ends 145, 146 with its straight retaining edges 54, 55 of the respective opening 53. The releasing tool is inserted into the insertion gap 27 between the insertion part flange and the sleeve part. In this case, the free ends 145, 146 of the two retaining arms 45, 46 are pushed in the direction of the insertion part 3, i.e. radially inward referred to the retaining element 4. This is indicated with arrows P1 in FIGS. 5a and 5b and in FIG. 6. In order to guide and hold the two straight retaining edges 54, 55 on the collar body 44, this collar body features flattened guiding segments 140, 141, which are recessed and respectively form or feature guiding surfaces, in the respective regions located adjacent to the two retaining arms 45, 46 or the gap 49 flanking these retaining arms. This is illustrated in FIGS. 3a and 3b, as well as in FIG. 3b. According to the latter figure, the two straight retaining edges 54, 55 of the respective elbowed, fork-shaped section 50, 51 of the releasing tool 5 engage and are guided along the guiding segments 140, 141 and the free ends 145, 146 of the retaining arms 45, 46, which are flanked by the two guiding segments 140, 141 (at a distance therefrom), are arranged on the retaining element such that they are respectively pressed in the direction of the interior of the retaining element or in the direction of the insertion part 3 to such a degree that the two retaining projections 47, 48 are disengaged from the locking surface 20 of the locking groove 21 of the sleeve part 2 (see also FIG. 5a).

FIGS. 6 and 7, in particular, show that the arrangement of the web 59 on the releasing tool 5 enables this releasing tool to contact the flange 31 of the insertion part 3 with its outer surface 150 on the one hand and the outer side of the sleeve part 2 on the other hand. The sleeve part 2 is illustrated in the form of a detailed section in FIGS. 4 and 5a, in the form of a side view in FIG. 5b, merely indicated perspectively in FIG. 6 and illustrated in the form of a perspective view in FIG. 7. Similar to the insertion part 3, the sleeve part 2 comprises a connecting section 23 that may be designed for fitting or expansion-fitting a pipeline thereon as shown. It is likewise possible to realize the connecting section 23 in the form of a hose connector and/or a plug connector and/or an adapter for producing an integral connection such as, for example, a soldered or welded adapter. The connecting section 23 may be designed, for example, for soldering in a cooling plate. Furthermore, the insertion part, as well as the sleeve part, may not only be realized in the form of a straight connector, but also in the form of an angular connector and/or a multiple connector that features more than two connecting ends. In addition to the connecting section 23, the sleeve part 2 illustrated in FIGS. 4 and 5a also comprises a sleeve section 24 that features the receiving opening 28 and the aforementioned locking groove 21 with the locking surface 20. After the retaining element 4 attached to the insertion part 3 has been interlocked, the retaining element and the accommodating segment 32 of the insertion part 3 primarily extend in the interior 25 of the sleeve section 24 of the sleeve part 2 like the end section 33 of the insertion part 3. The corresponding medium can be prevented from escaping from the connector 7 created by assembling and interlocking the insertion part 3 and the sleeve part 2 by arranging the sealing ring 6 on the end section 33. In the interlocked state between the insertion part 3 with its retaining element 4 and the sleeve part 2, the insertion gap 27 indicated in FIGS. 5a, 5b and 6 remains between the flange 31 of the insertion part 3 and the end face 26 of the sleeve section 24. The releasing tool 5 can be inserted into this insertion gap 27 with its fork-shaped sections 50, 51 in order to release the interlocked connection between the insertion part with its retaining element and the sleeve part. As already mentioned above, this is illustrated in FIG. 7.

In order to largely prevent incorrect positioning of the releasing tool 5 during an attempt to release the interlocked connection between the retaining element and the sleeve part and to likewise simplify the releasing process or the process of locating the correct position for the releasing tool 5 on the retaining element 4, projecting elements 340 of the type already indicated in FIG. 5b are provided in the embodiment of the retaining element 4 illustrated in FIGS. 9-11. The characteristics of the retaining element 4 described above with reference to FIGS. 1, 3a-3e and 6 can also be found in the perspective view of the retaining element 4 illustrated in FIG. 9. In addition, four projecting elements 340 are provided between the retaining arms 45, 46 in the region of the collar body 44. These protruding elements have such dimensions that their radial clearance a from an imaginary center axis M of the retaining element 4 is greater than the radius r of the sleeve part 2 in the region of its sleeve section 24. The four projecting elements 340 therefore protrude over the sleeve part 2 as indicated in FIG. 10. In this way, they are visible from outside such that it can be determined where the releasing tool 5 has to be positioned through the insertion gap 27 because the free ends of the retaining arms 45, 46 are arranged at an angle of approximately 90° to the projecting elements 340 as indicated in FIG. 11. After positioning the releasing tool 5, the projecting elements 340 are supported on its web 59 such that a limit stop for the release position of the releasing tool 5 is thereby defined. The releasing tool then contacts and is held on guiding surfaces 341, 342, which extend on the collar body 44 in a section adjacent to the free end 146 of the retaining arm 46 and laterally on the projecting elements 340, with its retaining edges 54, 55. With respect to their function, the guiding surfaces 341, 342 correspond to the guiding segments 140, 141 of the retaining element according to FIGS. 3a-3e, but merely extend laterally on the collar body 44 and the projecting elements 340. The releasing tool 5 secures itself on the retaining element 4 with its retaining edges 54, 55 due to its support on the guiding surfaces 341, 342 while simultaneously pushing down the free ends 145, 146 of the two retaining arms 45, 46. The plug connection between the insertion part and the sleeve part can be separated without having to take hold of a line connected to the sleeve part 2 or the insertion part 3 by pulling the releasing tool in the direction away from the sleeve part 2. This is particularly advantageous if only limited space is available at the installation site of the connector.

If applicable, the projecting elements 340 may be colored such that they are even easier to locate from a distance. The protruding elements therefore also serve as connection indicator means, wherein they can fill out the gap between the flange 31 and the end face of the sleeve part without clearance in the assembled state of the connector as indicated in FIG. 10. In bundled connectors 7, in particular, the respective insertion gap 27 for the releasing tool 5 therefore can be quickly and easily located because the projecting elements 340 provide an orientation aid. The arrangement of a collar on the end of the retaining element 4 makes it possible to effectively prevent an incorrect installation thereof because this collar would otherwise be in the way and thereby prevent the installation if it is attempted to incorrectly install the retaining element in a position, in which it is turned by 180° referred to the axial direction.

The insertion part 3, the sleeve part 2 and the retaining element 4 may be made of different materials, particularly of plastic and/or metal, wherein it is also possible, in particular, to use a fiber reinforced plastic such as a glass-fiber reinforced plastic. If a glass-fiber reinforced plastic is used for the insertion part 3, as well as for the retaining element 4, it is advantageous to provide a higher glass fiber content for the insertion part than for the retaining element. The sleeve part may likewise consist of plastic and/or metal such as, for example, aluminum. All components of the connector 7 may be made, in particular, of high-temperature materials in order to allow its use under high temperatures such as, e.g., in the exhaust gas system of a motor vehicle.

Instead of arranging the retaining element 4 on the insertion part 3 as illustrated in the above-described figures, the retaining element can also be used directly on a pipeline and that is correspondingly formed or integrally molded and/or shaped and/or upset in order to provide a suitable shape for creating an accommodating segment for accommodating the retaining element. The accommodating segment for accommodating the retaining element makes it possible to captively secure the retaining element in the axial direction. A rotational lock such as an arrangement of webs, e.g. the webs 39, 139, is difficult to realize on such integrally molded or formed pipe ends, but may basically also be provided in such instances. It would also be possible to provide other types of rotational locks such as, for example, small transverse bores and/or surfaces or flattened regions on the outer contour of the pipeline ends. Instead of the webs 39, 139, transverse bores and flattened regions, which likewise form a rotational lock, may be provided on the insertion part 3 as illustrated in the figures.

FIG. 12 shows a perspective view of the insertion part 3 with attached retaining element 4 according to FIG. 10, however, after the removal of the sleeve part 2. Accordingly, the projecting elements 340 of the retaining element 4 with the laterally arranged guiding surfaces 341, 342 for respectively engaging with the releasing tool 5 or its retaining edges 54, 55, as well as the retaining arms 45, 46 and the gap or clearance 40 between the two ends 41, 42 of the retaining element 4, are clearly visible in this figure. In addition, the ring seal 6 is installed on the insertion part or in its groove 34, respectively.

According to FIG. 13, no web 39 for preventing a rotation of the retaining element 4 on the insertion part 3 is provided on the insertion part 3 in the variation illustrated in FIG. 12 and FIG. 13, but rather two oppositely arranged flattened regions 300 that engage with likewise plane or flat elements 302 protruding on the inner side of the retaining element 4. This also makes it possible to prevent an inadvertent rotation of the retaining element 4 relative to the insertion part 3 in its accommodating segment 32 because the surface of the element 302 contacts the flattened region 300.

Alternatively to providing at least one web or flattened regions or other diametrically opposed elements on the retaining element 4 and on the insertion part 3, it would also be possible to take other measures for preventing an inadvertent rotation of the retaining element 4 on the accommodating segment 32 of the insertion part 3. Instead of the flattened regions, it would be possible to provide other geometric contours such as, for example, a polygon, if applicable in dependence on the number of retaining arms. The clearance made available for inserting the releasing tool and therefore for releasing the connection particularly can be defined with the chosen contour.

In the schematic side view of the retaining element 4 illustrated in FIG. 14, connection indicator means 400 are provided in the two gaps 49 flanking the retaining arm 46. In this case, the ends of the connection indicator means 400 extend in the gaps 49 adjacent to the ends of the retaining arm 46 and the collar body 44 or at a location along the longitudinal extent of the gaps 49. The connection indicator means are realized, in particular, in the form of a thin connecting web or integral hinge. The connection indicator means 400, which initially are connected to the adjacent regions of the retaining element, i.e. to the respective end of the respective retaining arm 45, 46, as well as to the collar body 44 of the retaining element 4, audibly break off when the retaining element 4 is expanded and thereby generate an additional connecting noise. In this way, an acoustically perceivable signal is generated. The connection indicator means may furthermore be colored such that their integrity can also be visually determined. The still existing continuity of the circumferential edge of the retaining element 4 provided in the region of the connection indicator means also makes it possible to visually determine its integrity, namely in that a circumferential edge is visible instead of individual segments. The connection indicator means 400 particularly serve for determining whether or not the sleeve part 2 has already been removed from the insertion part 3. When it is attempted to release the plug connection between the sleeve part with its retaining element and the insertion part, the connection indicator means break off the respective adjacent regions of the retaining arms and the collar body 44 when the retaining element is expanded due to the actuation of the retaining arms by means of the releasing tool 5, wherein this can be perceived acoustically when the connection indicator means break off and then perceived visually. In addition to coloring the connection indicator means, they may also be realized, for example, such that they change color when they break or break off and therefore make it possible to visually perceive their compromised integrity.

FIG. 15 shows a partial perspective view of a retaining element. In the region of its retaining arm 45, this retaining element features a tab element 410 that protrudes approximately perpendicular from the end of said retaining arm. According to FIG. 16, which in the left portion shows a detail of an interlocking position of the retaining element 4 according to FIG. 15 in a sleeve part 2 and in the right portion shows a releasing position thereof, the retaining element can be released if a force is exerted upon the retaining arm 45 in the direction of the arrow P2 by taking hold of the tab element 410. Due to the approximately perpendicular arrangement of the tab element 410 referred to the longitudinal extent of the retaining arm 45, the force accordingly acts upon the retaining arm 45 approximately perpendicular and therefore can release this retaining arm or its retaining projection 47 from the interlocked position on the locking surface 20 of the locking groove 21 of the sleeve part 2. This is indicated in the right portion of FIG. 16.

The left portion of FIG. 16 furthermore shows that the tab element 410 protrudes over the outer contour of the insertion part and the sleeve part through the insertion gap 27 after the assembly of the insertion part and the sleeve part with its retailing element and therefore can be correspondingly actuated from outside. This is also indicated with the arrow P2 in FIG. 16. Furthermore, it is naturally also possible to realize the tab element in such a way that it ends flush with the outer contour of the insertion part and/or the sleeve part. The plug connection can also be released if the tab element 410 ends flush with the outer side of the insertion part and the sleeve part by engaging on the tab element with a releasing tool, particularly a releasing tool 5 of the type illustrated in FIGS. 8a and 8b.

The releasing tool 5 can not only be used for releasing the connection between the insertion part with its retaining element and the sleeve part, but also for the installation of the sleeve part on the insertion part because the retaining arms 45, 46 of the retaining element 4 can be interlocked in the locking groove 21 of the sleeve part much easier when they are pushed down than in the state of the retaining arms, in which they are not pushed down as illustrated, for example, in FIGS. 3b and 9. FIGS. 7 and 10, in particular, show that the arrangement of the retaining element 4, which is accommodated on the accommodating segment 32 of the insertion part 3, does not create an outwardly protruding option for releasing a releasable plug connection, in which the retaining element is captively secured. In contrast to the prior art, no locking or unlocking elements protrude over the outer side of the connector 7 and therefore are not at risk of being separated such that the plug connection can subsequently no longer be released. In order to release or unlock the plug connection, the opening elements in the form of the retaining arms with retaining projections arranged thereon do not have to be directly actuated manually, but rather with the aid of the releasing tool such that the risk of an authorized separation, as well as the risk of an inadvertent separation, can thereby be significantly reduced.

In addition to the variations of connectors described above and illustrated in the figures, particularly connectors for hose lines or pipelines which comprise at least one sleeve part and at least one insertion part and in which the insertion part is inserted into a receiving opening of the sleeve part and at least one retaining element is provided for releasably locking the insertion part in the sleeve part, it is also possible to create numerous other variations, namely also combinations of the above-described variations, in which the retaining element and the insertion part respectively have a two-piece design and in which the retaining element can be radially expanded and accommodated on an accommodating segment of the insertion part in a captive and rotationally locked fashion, wherein the retaining element is attached to the accommodating segment radially or axially depending on its elasticity and features at least one retaining arm with at least one outwardly protruding retaining projection, and wherein the retaining arm extends approximately parallel to the insertion axis of the insertion part and can be elastically moved relative to the insertion part in the radial direction in order to interlock or unlock the retaining projection with/from a locking surface of the sleeve part. Guiding surfaces and/or guiding segments are provided on the retaining element body adjacent to the free end of the at least one retaining arm in order to attach the releasing tool to the retaining element in a guided fashion and to thereby release the connection between the insertion part with its retaining element and the sleeve part.

### LIST OF REFERENCE SYMBOLS

1 Set
2 Sleeve part
3 Insertion part
4 Retaining element
5 Releasing tool
6 Ring seal
7 Connector
20 Locking surface
21 Locking groove
22 Outer side
23 Connecting section
24 Sleeve section
25 Interior
26 End face
27 Insertion gap
28 Receiving opening
30 Connecting section
31 Flange
32 Accommodating segment
33 End section
34 Groove
35 First inner section
36 Second section
37 Protruding section
38 Longitudinal connector axis
39 Web
40 Gap
41 End
42 End
43 Longitudinal groove
44 Collar body
45 Retaining arm
46 Retaining arm
47 Retaining projection
48 Retaining projection
49 Gap
50 First elbowed, fork-shaped section
51 Second elbowed, fork-shaped section
52 Web
53 Opening
54 Straight retaining edge
55 Straight retaining edge
56 Arc-shaped section
57 Insertion edge
58 Insertion edge
59 Web
131 Axial surface
136 Axial contact surface
137 Axial surface
139 Web
140 Recessed, flattened guiding segment
141 Recessed, flattened guiding segment
142 Axial contact surface
143 Axial end face
144 Axial end face
145 Free end
146 Free end
147 Shoulder
148 Shoulder
150 Outer surface
245 Fixed end
246 Fixed end
300 Flattened region
302 Protruding element
340 Projecting element
341 Guiding surface
342 Guiding surface
400 Connection indicator means
410 Tab element
M Center axis of 4
a Distance
r Radius
l Length of 4
d Diameter of 4
P1 Arrow
P2 Arrow

What is claimed is:

1. A connector, particularly for hose lines and/or pipelines, comprising: at least one sleeve part and at least one insertion part, wherein the insertion part is insertable or inserted into a receiving opening of the sleeve part, and wherein at least one retaining element is provided for releasably locking the insertion part in the sleeve part, wherein the retaining element and the insertion part have a two-piece design and the retaining element is radially expandable, wherein said retaining element is mountable or mounted on an accommodating segment of the insertion part in a captive and rotationally locked fashion and features at least one retaining arm with at least one outwardly protruding retaining projection, wherein the at least one retaining arm has a free end and an end fixed on a retaining element body and is elastically movable in the radial direction relative to the insertion part in order to interlock and release the at least one retaining projection on/from at least one locking surface of the sleeve part, and wherein at least one guiding segment and/or at least one guiding surface is provided on the retaining element body adjacent to the free end of the at least one retaining arm in order to attach a releasing tool to the retaining element in a guided fashion and to thereby release the connection between the insertion part with its retaining element and the sleeve part.

2. The connector according to claim 1, wherein an insertion gap, which serves for inserting the releasing tool for engaging on the at least one retaining arm and for thereby releasing the at least one retaining projection from the locking surface in the sleeve part, is provided between the insertion part and the sleeve part in the interlocked position of the insertion part with its retaining element and the sleeve part.

3. The connector according to claim 1, wherein two oppositely arranged retaining projections are provided.

4. The connector according to claim 1, wherein the insertion part is provided with at least one rotational lock for the retaining element, wherein the rotational lock is formed by at least one element that radially protrudes from the accommodating segment for accommodating the retaining element.

5. The connector according to claim 1, wherein the insertion part is provided with at least one rotational lock for the retaining element, wherein the rotational lock is formed by at least one flattened region that cooperates with a flattened region of the retaining element.

6. The connector according to claim 1, wherein the retaining element features on its inner side at least one offset for engaging with a complementary offset of the insertion part.

7. The connector according to claim 1, wherein the retaining element body of the retaining element features on its outer side projecting elements that serve as a positioning aid during the attachment of a releasing tool for releasing the connection between the retaining element attached to the insertion part and the sleeve part.

8. The connector according to claim 1, characterized in that wherein at least one axial supporting surface for the retaining element is provided on the insertion part for transmitting forces.

9. The connector according to claim 2, wherein the guiding surfaces of the retaining element consist of flattened and/or pocketed regions on the retaining element body, particularly on elements of the retaining element body which laterally project from its end and extend into the insertion gap.

10. The connector according to claim 1, wherein the accommodating segment of the insertion part is on its ends bordered by protruding sections thereof in order to define the accommodating segment for the retaining element, wherein at least one protruding flange is provided in the region of the free end of the at least one retaining arm.

11. The connector according to claim 1, wherein the insertion part and the retaining element are made of different materials, wherein the insertion part is made of metal and/or plastic and the retaining element is made of plastic.

12. A releasing tool for releasing the connection between an insertion part provided with a retaining element and a sleeve part of a connector according to claim 1, wherein an insertion gap is provided between the sleeve part and a protruding flange of the insertion part in the interlocked state of the connector, wherein the releasing tool features at least one fork-shaped section with a c-shaped opening, wherein the c-shaped opening features retaining edges for engaging on the retaining arms and at least one guiding segment and/or at least one guiding surface of the retaining element.

13. The releasing tool according to claim 12, wherein at least one web is provided as a positioning aid and at least partially encloses the inner c-shaped opening of the fork-shaped section of the releasing tool at a distance therefrom, wherein the opening width of the space enclosed by the web is dimensioned slightly larger than the outside diameter of the sleeve part, but smaller than the outside diameter of a flange of the insertion part arranged adjacent to the insertion gap.

14. A set comprising a connector and a releasing tool for releasing the connection between an insertion part provided with a retaining element and a sleeve part of the connector according to claim 1, wherein the sleeve part and the insertion part are designed in such a way that an insertion gap for inserting the releasing tool remains after the sleeve part and the insertion part with its retaining element have been inserted into one another, and in that the releasing tool is in a section realized in a fork-shaped fashion with at least one c-shaped opening for being inserted into the insertion gap, wherein the inner c-shaped opening has such dimensions that retaining edges of the inner opening are during the engagement on the retaining element held on at least one guiding segment and/or at least one guiding surface of the retaining element body adjacent to the retaining arms of the retaining element and retaining projections of the retaining arms of the retaining element are radially moved so far in the direction of the insertion part that they are disengaged from the locking surface of the sleeve part.

15. The set according to claim 14, wherein at least one web, which at least partially encloses the inner c-shaped opening, is provided as a positioning aid on the outer side of the sleeve part at a distance from the inner c-shaped opening.

16. The connector according to claim 11, wherein the insertion part is plastic with a glass fiber content, wherein the retaining element is plastic with a glass fiber content, and wherein the insertion part has a higher glass fiber content than the retaining element.

17. The connector according to claim 2, wherein two oppositely arranged retaining projections are provided.

18. The connector according to claim 17, wherein the retaining element features on its inner side at least one offset for engaging with a complementary offset of the insertion part, and wherein the retaining element body of the retaining element features on its outer side projecting elements that serve as a positioning aid during the attachment of a releasing tool for releasing the connection between the retaining element attached to the insertion part and the sleeve part.

19. The connector according to claim 18, wherein at least one axial supporting surface for the retaining element is provided on the insertion part for transmitting forces, and wherein the guiding surfaces of the retaining element consist of flattened and/or pocketed regions on the retaining element body, particularly on elements of the retaining element body which laterally project from its end and extend into the insertion gap.

20. The connector according to claim 19, wherein the accommodating segment of the insertion part is on its ends bordered by protruding sections thereof in order to define the accommodating segment for the retaining element, wherein at least one protruding flange is provided in the region of the free end of the at least one retaining arm, and wherein the insertion part and the retaining element are made of different materials, wherein the insertion part is made of metal and/or plastic and the retaining element is made of plastic.
